(19) United States
(12) Patent Application Publication
(10) Pub. No.: US 2008/0123472 A1
(43) Pub. Date: May 29, 2008

(54) Alarm Clock Interface

(76) Inventor: Gary F. Bart, Miramar, FL (US)

Correspondence Address: HUSCH BLACKWELL SANDERS LLP, 4801 Main Street, Suite 1000, KANSAS CITY, MO, 64112, US

(21) Appl. No.: 11/834,682

(22) Filed: Nov. 20, 2007

Related U.S. Application Data
(60) Provisional application No. 60/821,539, filed on Aug. 4, 2006.

(51) Int. Cl. G04C 21/00; G04B 47/00

(52) U.S. Cl. 368/10; 368/73

(57) ABSTRACT

There is provided according to an embodiment of the present inventive interface and method, an alarm clock having an interface comprising: a display configured to display a plurality of command options wherein each of said command options corresponds to an interface function; a first control element configured to have a default function when rotated; the first control element configured to have a first function when pressed and a second function when rotated after being pressed.

### CROSS-REFERENCE TO RELATED APPLICATIONS

This application claims priority to U.S. Provisional patent application No. 60/821,539 entitled “Alarm Clock Interface” filed Aug. 4, 2006.

### BACKGROUND OF THE INVENTION

The alarm clock is a common item that has been around for a considerable length of time in one form or another. Given the ubiquitous nature and the length of time the alarm clock has been in use, it is understandable that the common alarm clock has enjoyed a number of improvements over this period of time. New features have been added (such as auto time setting via atomic clock signal, variable backlight display intensity, variable backlight color selection), new sources have been added (compact disc players, portable digital music players, weather radio band), and components have been improved (multiple speakers, amplifiers).

Yet despite addition of new features such as the above described improvements, the basic interface for performing alarm clock operations has remained largely unchanged since the advent of the digital alarm clock. Buttons and multi position switches are used to set the current time, set the alarm time, choose an audio source, etc.

Increased functionality has pushed the boundaries of conventional alarm clock interface design and has resulted in the addition of yet more buttons, slide switches and the like. Accordingly, an improved alarm clock interface is needed.

### SUMMARY OF THE INVENTION

There is provided according to one aspect of the present inventive interface, an alarm clock having an interface comprising: a display configured to display a plurality of command selections wherein each of the command selections corresponds to an alarm clock function; a first user control configured to navigate through the plurality of command selections; and a second user control configured to select one of the plurality of command selections.

There is further provided in the inventive method and interface, a method for controlling the operation of an alarm clock having an interface comprising the steps of: displaying a plurality of menus of command selections on a display, each menu of the plurality of menus of command selections corresponding to a group of alarm clock operations; receiving one or more inputs from a user control, each of the one or more inputs corresponding to a command selection from each menu of the plurality of menus of command selections; and performing an alarm clock operation that corresponds to the command selection.

There is yet further provided according to an embodiment of the present inventive interface and method, an alarm clock having an interface comprising: a display configured to display a plurality of command options wherein each of said command options corresponds to an interface function; a first control element configured to have a default function when rotated; the first control element configured to have a first function when pressed and a second function when rotated after being pressed.

Certain embodiments of the invention are outlined above in order that the detailed description thereof may be better understood, and in order that the present contributions to the art may be better appreciated. There are, of course, additional embodiments of the invention that will be described below and which will form the subject matter of the claims appended hereto.

In this respect, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE SEVERAL VIEWS OF THE DRAWING

Further features of the present invention will become apparent to those skilled in the art to which the present invention relates from reading the following description with reference to the accompanying drawings, in which:

FIG. 1 is a perspective view of an alarm clock radio according to an embodiment of the present invention;

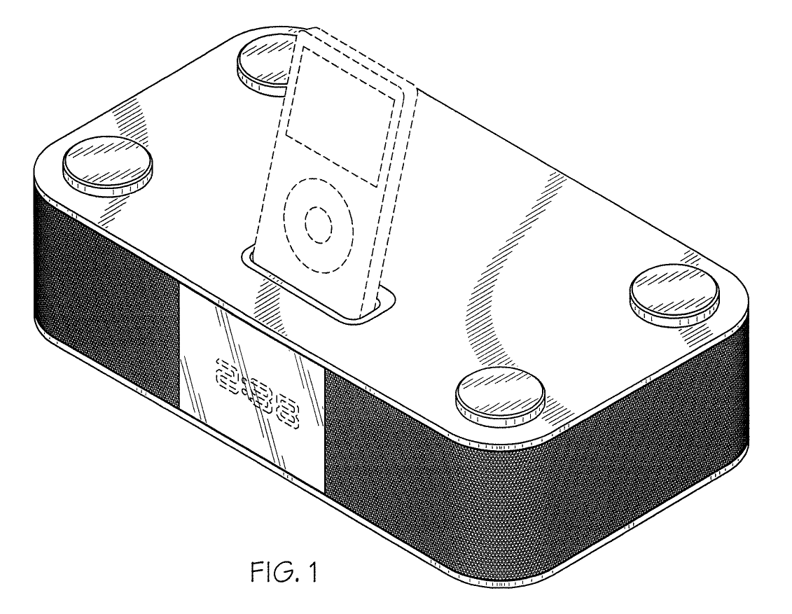

FIG. 2 is a front view of an alarm clock radio according to an embodiment of the present invention;

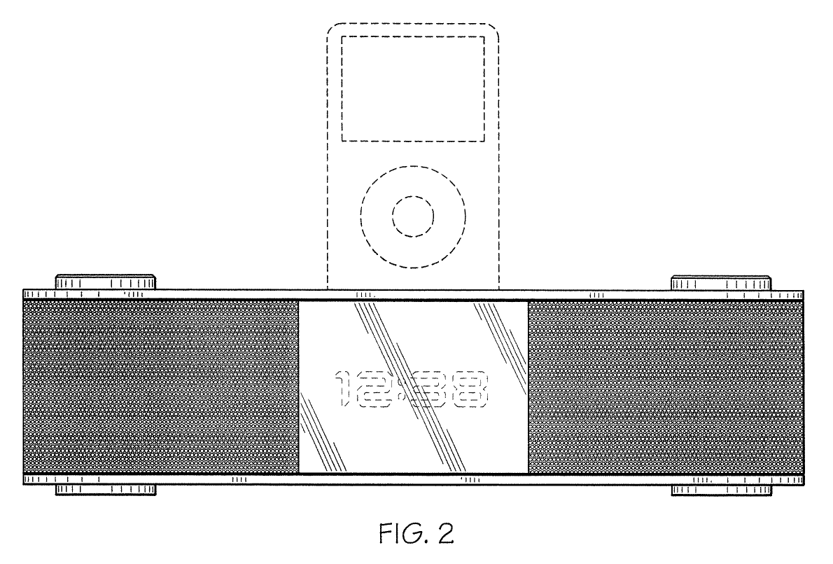

### DETAILED DESCRIPTION OF THE INVENTION

An embodiment of the invention provides an interface for an alarm clock mini speaker system with radio, buzzer, and connectivity for an external source such as an iPod® digital media player. According to this embodiment, the user operates the clock radio using a hierarchical menu interfaces and two knobs to select menu options.

According to an embodiment of the invention, the alarm clock features a radio (am/fin) and connectivity for an external source. In some embodiments the above described connectivity may include a dock platform that is configured to be mated to a specific external source/player such as an iPod®. Other embodiments may have an auxiliary input jack with a standard portable device connector. Audio output may be accomplished using two 1.5″ midrange speakers, two 1″ tweeters and a 2.5″ subwoofer, although any speaker configuration may be used.

One embodiment of the invention includes two knobs for user interface operations. In this embodiment the user makes selections from the menu interface using one or more knobs. Preferably the knobs are rotatable, push switches with tactile switches for pressing and infinite loop potentiometer/encoders for rotational input. According to some embodiments, only a single knob is used to operate the radio. Additionally, one or more other input types may be used in place of, or in conjunction with, a knob. One example of another input type is a tactile touch-sensitive controller such as the Synaptics “Touchpad” that uses capacitive touch sensing technology. According to some embodiments of the present invention, some or all of the alarm clock operations may be performed using a remote control.

According to one configuration of the invention, pushing the right knob causes the clock screen to display a menu interface. Further to this configuration, rotating the right knob will navigate the menu options, pushing the right knob will select the highlighted while in the menu option, pushing the right knob while the alarm is going off will turn the alarm off, rotating the right knob will tune the radio while in radio mode, and rotating the right knob will dim the LCD if the user is not in the menu or radio mode. Further according to this configuration, pushing the left knob will turn on or off the selected clock audio source, rotating the left knob will adjust the volume, and pushing the left knob will snooze the alarm when the alarm is going off.

Menu's are displayed as the menu button is pressed and rotating the menu knob scrolls the menu items and selected simply by pressing the menu knob. Menu options are organized and grouped in sub menus and options. The scroll bar will blink twice when a menu item is selected to provide visual feedback to the user. Informational items present on the display may include, the current time, and date as well as the set alarm times. Additionally, some configurations will enable the user to display the wake to (source) at all times while not in menu mode.

When an external source, such as an iPod® is selected, the radio display will show the song title and artist info will be scrolled below the time display as the iPod® is being played. While the volume, LCD brightness, EQ levels are adjusted either through the remote or the knobs on the unit, the display will show the scale and the corresponding setting value of the adjusted item.

In some embodiments of the present invention, the user can set up to two alarms each of which can be set to go off either once the next day or can be set to go off any combination of days that will continue week after week. Each alarm clock can be set to wake to the iPod®, AM radio, FM radio, or buzzer. Additionally, the snooze duration for each alarm setting is independently adjustable.

According to an embodiment of the present inventive interface, the following options are described.

Left Control Knob: To toggle through source options, turn audio off, and activate snooze while the alarm is sounding. To access Radio menu: To control volume when an audio source is playing or increase/decrease snooze time when in snooze mode.

Alarm 1 Button: To activate/deactivate Alarm 1, To enter Alarm 1 menu

Alarm 2 Button: To activate/deactivate Alarm 2, To enter Alarm 2 menu

Right Control Knob: To enter the main menu, select a menu item or reset the daily alarm when the alarm is sounding, To exit the main menu or to activate the sleep timer when an audio source is playing.

To navigate through the menu, increase/decrease the sleep time when in sleep mode or increase/decrease the brightness of the display when not in menu or sleep mode

According to one embodiment, the alarm clock unit is controlled using the two control knobs at the front of the unit and the two buttons at the rear of the unit. The alarm clock unit menu system provides a hierarchical menu interface.

The following examples are drafted in such as manner as to guide the operator through the unit features and settings starting from the main screen where the time and date are displayed.

According to another embodiment of the invention, to return to the main screen from any menu, turn the Right Control Knob until the “Exit” menu item is highlighted and push to select. Alternatively, it is possible to push and hold the Right Control Knob to exit the menu, or allow the menu to timeout after 30 seconds of inactivity. It will be appreciated that according to some embodiments of the present invention, when making changes to settings, the unit will not save the changes unless the user has accepted the changes by pressing the Right Control Knob.

According to an embodiment of the present inventive interface, in order to set the time: 1. Push the Right Control Knob to access the main menu. The menu will appear on Luna's display. 2. Turn the Right Control Knob until the “Settings” menu item is highlighted and push to select. 3. Push the Right Control Knob again to select the “Time” menu item. The hour will blink to indicate that it can be adjusted. Turn the Right Control Knob to change the hour, AM or PM (indicated by an “A” or “P” next to the time) and push to accept the correct hour and advance to adjust the minutes. 4. The minute section will then blink to indicate that it can be adjusted. Turn the Right Control Knob to change the minutes and push to accept and save your changes.

According to an embodiment of the present inventive interface, to set the Date: 1. Push the Right Control Knob to access the main menu. The menu will appear on the unit display. 2. Turn the Right Control Knob until the “Settings” menu item is highlighted and push to select. 3. Turn the Right Control Knob until the “Date” menu item is highlighted and push to select. 4. Push the Right Control Knob again to select the year. The year will blink to indicate that it can be adjusted. Turn the Right Control Knob to change the year and push to accept and save your changes. 5. Turn the Right Control Knob again until the “Month” menu item is highlighted and push to select. The month will then blink to indicate that it can be adjusted. Turn the Right Control Knob to the change the month and push to accept and save your changes. 6. Turn the Right Control Knob again until the “Day” menu item is highlighted and push to select. The day will then blink to indicate that it can be adjusted. Turn the Right Control Knob to the change the day and push to accept and save your changes.

According to an embodiment of the present inventive interface, in order to set the Display Options: 1. Push the Right Control Knob to access the main menu. The menu will appear on the unit's display. 2. Turn the Right Control Knob until the “Settings” menu item is highlighted and push to select. 3. Turn the Right Control Knob until the “Display Options” menu item is highlighted and push to select. 4. Turn the Right Control Knob to highlight either “Contrast” or “Dimmer” and push to select. The level will blink to indicate that it can be adjusted. 5. Turn the Right Control Knob to increase/decrease the level for contrast (from 0 to 60) and for the dimmer (from 0 to 20) push to accept and save your changes. If you set the dimmer to a level lower than 5, touching any control will automatically bring the dimmer up to a level 5 for a few moments so that you can make adjustments to your settings.

According to an embodiment of the present inventive interface, in order to set the Date and Time Format: The unit default date format is Month, Day, Year (MM.DD.YY) and default time format is a 12-hour clock. To select Day, month, year (DD.MM.YY) and/or to select a 24-hour clock format, follow these instructions: 1. Push the Right Control Knob to access the main menu. The menu will appear on Luna's display. 2. Turn the Right Control Knob until the “Settings” menu item is highlighted and push to select. 3. Turn the Right Control Knob until the “Format” menu item is highlighted and push to select. 4. Turn the Right Control Knob to highlight either “Time Format” or “Date Format” and push to select. 5. Turn the Right Control Knob to highlight your preferred format and push to select. This will automatically turn the selected format to “ON” the other format to “OFF”.

According to an embodiment of the present inventive interface, it is possible to set the Daylight Savings Time Option as follows: 1. Push the Right Control Knob to access the main menu. The menu will appear on the unit's display. 2. Turn the Right Control Knob until the “Settings” menu item is highlighted and push to select. 3. Turn the Right Control Knob until the “DST” menu item is highlighted and push to toggle between “OFF” and “ON”. Activate this feature when Day Light Savings Time is in effect. This will advance the time one hour.

Setting the Alarms. According to one embodiment of the present inventive alarm clock and interface, the unit's two alarms work independently from each other, allowing the user to customize each one according to preference. It is possible for the user to set the time, wake to source, volume/volume ramping, dimmer brightness and even snooze time for each. For example, according to one embodiment of the present inventive interface, one sets the time as follows: 1. Push the Right Control Knob to access the main menu. The menu will appear on the unit's display. 2. Turn the Right Control Knob to highlight either “Alarm 1” or “Alarm 2” and push to select. 3. Push the Right Control Knob again and the hour will blink to indicate it can be adjusted. Turn the Right Control Knob to change the hour, AM or PM (indicated by an “A” or a “P” next to the time) and push to accept the correct hour and advance to adjust the minutes.

It will be further appreciated by one of skill in the art that according to some embodiments of the present inventive interface, shortcuts to certain functions may be provided. For example, it is possible for the user to turn the Right Control Knob to increase/decrease the brightness of the display at any time, except when in menu or sleep mode.

Certain embodiments of the invention are outlined above in order that the detailed description thereof may be better understood, and in order that the present contributions to the art may be better appreciated. There are, of course, additional embodiments of the invention that will be described below and which will form the subject matter of the claims appended hereto.

In this respect, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

One of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

We claim:

1. An alarm clock having an interface comprising:
a display configured to display a plurality of command selections wherein each of said command selections corresponds to an alarm clock function;
a first user control configured to navigate through said plurality of command selections; and
a second user control configured to select one of said plurality of command selections.

2. The alarm clock of claim 1 wherein an alarm clock function is playing audio from an internal radio tuner.

3. The alarm clock of claim 1 wherein an alarm clock function is playing audio from a digital media player.

4. The alarm clock of claim 1 wherein said first user control is a knob wherein said knob is rotatable.

5. The alarm clock of claim 1 wherein said second user control is a knob wherein said knob is a pushable switch.

6. The alarm clock of claim 1 wherein said first user control is a control knob wherein said control knob is rotatable and said second user control is said control knob which is also a pushable switch.

7. A method for controlling the operation of an alarm clock having an interface comprising the steps of:
displaying a plurality of menus of command selections on a display, each menu of the plurality of menus of command selections corresponding to a group of alarm clock operations;
receiving one or more inputs from a user control, each of said one or more inputs corresponding to a command selection from each menu of the plurality of menus of command selections; and
performing an alarm clock operation that corresponds to said command selection.

8. The method of claim 7 wherein one of said alarm clock operations is setting an alarm time.

9. The method of claim 7 wherein one of said alarm clock operations is selecting an alarm audio source.

10. An alarm clock having an interface comprising:
a display configured to display a plurality of command options wherein each of said command options corresponds to an interface function;
a first control element configured to have a default function when rotated;
said first control element configured to have a first function when pressed and a second function when rotated after being pressed.

11. The alarm clock of claim 10 wherein said first control element function is a volume control when rotated.

12. The alarm clock of claim 10 wherein said first control element function when pressed is a to display a menu on a screen and to change said first control element function to traverse menu options when rotated.

13. The alarm clock of claim 10 further comprising a second control element, wherein said second control element has a default function when rotated.

14. The alarm clock of claim 13 wherein said second control element also comprises a pushable switch.
